(19) United States
(12) Patent Application Publication
(10) Pub. No.: US 2014/0046667 A1
(43) Pub. Date: Feb. 13, 2014

(54) SYSTEM FOR CREATING MUSICAL CONTENT USING A CLIENT TERMINAL

(71) Applicants: Jong Hak Yeom, Gyeonggi Do (KR); Won Mo Kang, Chungbuk (KR)

(72) Inventors: Jong Hak Yeom, Gyeonggi Do (KR); Won Mo Kang, Chungbuk (KR)

(73) Assignee: TGENS CO., LTD, Munji-dong (KR)

(21) Appl. No.: 14/114,227

(22) PCT Filed: Apr. 17, 2012
(86) PCT No.: PCT/KR12/02897

§ 371 Date: Oct. 28, 2013

(30) Foreign Application Priority Data
Apr. 28, 2011 (KR) 10-2011-0040360

(51) Int. Cl. G10L 13/033

(52) U.S. Cl. CPC G10L 13/033
USPC 704/258

(57) ABSTRACT

A system for creating musical content using a client terminal, wherein diverse musical information such as a desired lyric and musical scale, duration and singing technique is input from an online or cloud computer, an embedded terminal or other such client terminal by means of technology for generating musical vocal content by using computer speech synthesis technology, and then speech in which cadence is expressed in accordance with the musical scale is synthesized as speech run by being produced for the applicable duration and is transmitted to the client terminal is provided.

### FIELD OF TECHNOLOGY

The following relates to a system for creating musical content using a client terminal, and more particularly, to a technology of creating musical/vocal content using a computer voice synthesis technology and a system for creating musical content using a client terminal, wherein, when various music information such as lyrics, musical scale, sound length and singing technique is input electronically or from the client terminal such as a cloud computer, embedded terminal, and the like, a voice representing a rhythm according to a musical scale is synthesized into a voice having a corresponding sound length and transmitted to the client terminal.

### BACKGROUND

Conventional voice synthesis technology simply outputs input text as voices in the form of conversation, and is limited to a simple information transfer function such as an automatic response service (ARS), voice guide, navigation voice guide, and the like.

Thus, there is a need for a character/voice synthesis technology that can be applied to various services, such as songs, musical compositions, musicals, intelligent robots and the like, using a technology of realizing all voice functions of persons together with a simple information transfer function.

In a personal computer (PC) environment, existing voice synthesis techniques for music require a series of processes for creating music, such as editing of lyrics and voice synthesis, to be performed in a single system.

In mobile or smart phone, electronic and cloud computer environments, it is difficult to process a database of a high capacity required for voice synthesis in a short time due to restriction of CPU performance and a limit of a memory, and there is a limit in performance upon multiple connections.

### SUMMARY

In order to solve such problems, the present invention provides a voice synthesis system for music based on a client/server structure. Therefore, the present invention has been conceived to solve such problems in the art, and an object of the present invention is to output a song synthesized according to lyrics, musical scale, and sound length using text-to-speech (TTS) of lyrics through electronic communication or in a client environment of various embedded terminals such as a mobile phone, PDA, and smartphone, or to transmit a song to the client environment after synthesizing a song corresponding to background music and lyrics.

Another object of the present invention is to provide a voice synthesis method for music, which processes music elements, such as lyrics, musical scale, sound length, musical effect, setting of background music and beats per minute/tempo, to create digital content, and synthesizes lyrics and a voice to display various musical effects by analyzing text corresponding to lyrics according to linguistic characteristics.

A further object of the present invention is to solve a problem of low performance by establishing a separate voice synthesis transmission server to send voice information for music synthesized in a short time by a voice synthesis server to a client terminal.

In accordance with one aspect of the present invention, a system for creating musical content using a client terminal includes: a client terminal for editing lyrics and a sound source, reproducing a sound corresponding to a location of a piano key, and editing a vocal effect or transmitting music information to the voice synthesis server to reproduce music synthesized and processed by the voice synthesis server, the music information being obtained by editing a singer sound source and a track corresponding to a vocal part; a voice synthesis server for acquiring the music information transmitted from the client terminal to extract, synthesize, and process a sound source; and a voice synthesis transmission server for transmitting the music created by the voice synthesis server to the client terminal.

According to the present invention, the system for creating musical content using a client terminal may allow anyone in a mobile environment to easily edit musical content, and may provide a musical voice corresponding to the edited musical content to a user through synthesis of the musical voice. Accordingly, the musical content creation system according to the invention may allow individually created musical content to be circulated through electronic or off-line systems, may be used for an additional service for application of musical content, such as bell sound and ringtone (ring back tone: RBT) in a mobile phone, may be used for reproduction of music and voice guide in various types of portable devices, may provide a voice guide services with an accent similar to a human voice in an automatic response system (ARS) or a navigation system (map guide device), and may allow an artificial intelligent robot to speak with an accent similar to a human voice and to sing.

In addition, the musical content creation system according to the invention may express a natural accent of a person instead of a radio performer in creating dramas or animated content.

Further, the musical content creation system according to the invention solves a problem of low performance using a separate voice synthesis transmission server to send information obtained by synthesizing a musical voice in a voce synthesis server to a client terminal, thereby enabling rapid provision of a sound source service to a plurality of clients.

### BRIEF DESCRIPTION

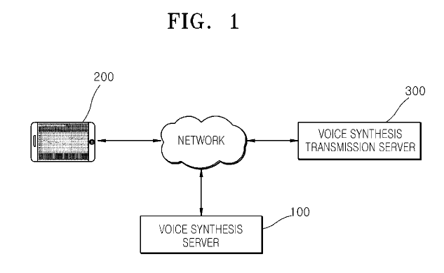

FIG. 1 is a diagram of a system for creating musical content using a client terminal in accordance with one embodiment of the present invention.

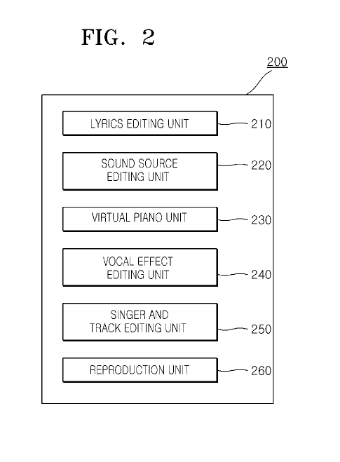

FIG. 2 is a block diagram of a client terminal in the system for creating musical content using a client terminal in accordance with one embodiment of the present invention.

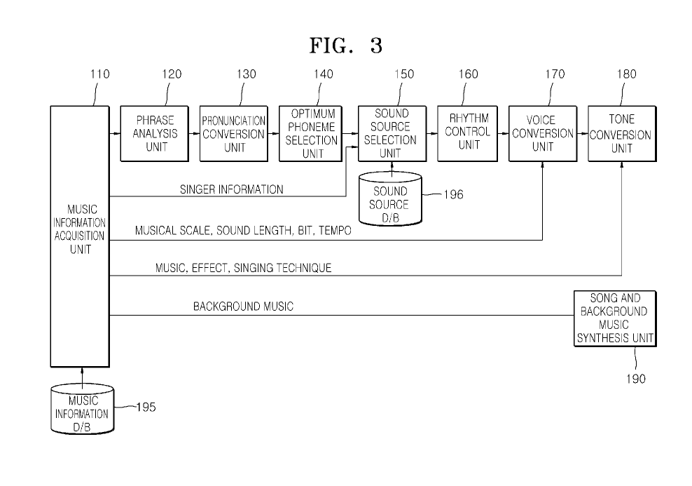

FIG. 3 is a block diagram of a voice synthesis server in the system for creating musical content using a client terminal in accordance with one embodiment of the present invention.

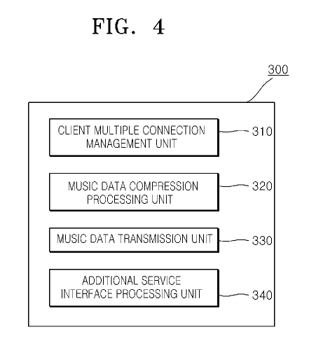

FIG. 4 is a block diagram of a voice synthesis transmission server of the system for creating musical content using a client terminal in accordance with one embodiment of the present invention.

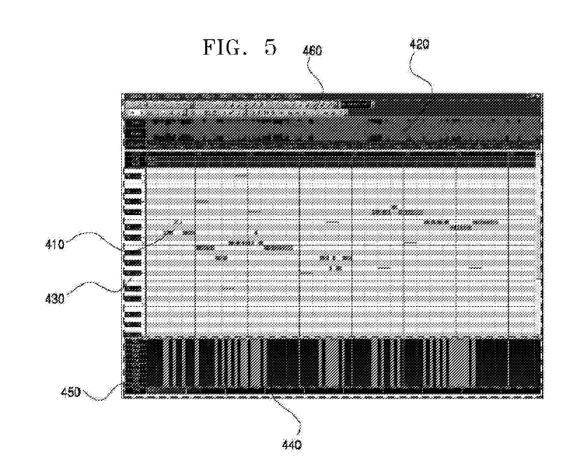

FIG. 5 is a screen illustrating a creation program output to the client terminal of the system for creating musical content using a client terminal in accordance with the embodiment of the present invention.

100: Voice synthesis server

200: Client terminal

300: Voice synthesis transmission server

### DETAILED DESCRIPTION

In accordance with one aspect of the present invention, a system for creating musical content using a client terminal includes: a client terminal for editing lyrics and a sound source, reproducing a sound corresponding to a location of a piano key, and editing a vocal effect or transmitting music information to the voice synthesis server to reproduce music synthesized and processed by the voice synthesis server, the music information being obtained by editing a singer sound source and a track corresponding to a vocal part; a voice synthesis server for acquiring the music information transmitted from the client terminal to extract, synthesize, and process a sound source; and a voice synthesis transmission server for transmitting the music created by the voice synthesis server to the client terminal.

The client terminal includes: a lyrics editing unit for editing lyrics; a sound source editing unit for editing a sound source; a vocal effect editing unit for editing a vocal effect; a singer and track editing unit for selecting a singer sound source corresponding to a vocal part and editing various tracks; and a reproduction unit for receiving and reproducing a signal synthesized by the voice synthesis server from the voice synthesis transmission server.

In accordance with another aspect of the invention, the client terminal includes: a lyrics editing unit for editing lyrics; a sound source editing unit for editing a sound source; a virtual piano unit for reproducing a sound corresponding to a location of a piano key; a vocal effect editing unit for editing a vocal effect; a singer and track editing unit for selecting a singer sound source corresponding to a vocal part and editing various tracks; and a reproduction unit for receiving and reproducing a signal synthesized by the voice synthesis server from the voice synthesis transmission server.

The voice synthesis server includes: a music information acquisition unit for acquiring lyrics, a singer, a track, a musical scale, a sound length, a bit, a tempo, and a musical effect transmitted from the client terminal; a phrase analysis unit for analyzing a sentence of the lyrics acquired by the music information acquisition unit and converting the analyzed sentence into a form defined according to linguistic characteristics; a pronunciation conversion unit for converting data analyzed by the phrase analysis unit based on a phoneme; an optimum phoneme selection unit for selecting an optimum phoneme corresponding to the lyrics analyzed by the phrase analysis unit and the pronunciation conversion unit according to a predefined rule; a sound source selection unit for acquiring singer information acquired by the music information acquisition unit and selecting a sound source, corresponding to the phoneme selected through the optimum phoneme selection unit from a sound source database, as a sound source of the acquired singer information; a rhythm control unit for acquiring an optimum phoneme selected by the optimum phoneme selection unit according to a sentence characteristic of the lyrics and controlling a length and a pitch when the optimum phonemes are connected to each other for synthesis; a voice conversion unit for acquiring a sentence of the lyrics synthesized by the rhythm control unit and matching the sentence of the acquired lyrics such that the sentence is reproduced according to a musical scale, a sound length, a bit, and a tempo acquired by the music information acquisition unit; a tone conversion unit for acquiring the voice converted by the voice conversion unit and matching a tone with the converted voice such that the tone is reproduced according to a musical effect acquired by the music information acquisition unit; and a song and background music synthesis unit for synthesizing background music information acquired by the music information acquisition unit with the tone finally converted by the tone conversion unit.

The music information acquisition unit includes: a lyrics information acquisition unit for acquiring lyrics information; a background music information acquisition unit for acquiring background music sound source information selected from background music sound sources stored in the sound source database; a vocal effect acquisition unit for acquiring vocal effect information adjusted by a user; and a singer information acquisition unit for acquiring singer information.

The system further includes a piano key location acquisition unit for acquiring piano key location information selected by a user from a virtual piano.

The voice synthesis transmission server includes: a client multiple connection management unit for managing music synthesis requests of a plurality of client terminals in sequence or in parallel such that the plurality of client terminals simultaneously connect to the voice synthesis server to issue voice synthesis requests; a music data compression processing unit for compressing music data to efficiently transmit the music data in a restricted network environment; a music data transmission unit for transmitting music information synthesized in response to the music synthesis request of the client terminal to a client; and an additional service interface processing unit for transferring voice synthesis based musical content to an external system to provide the musical content to a mobile communication company bell sound service and a ringtone service.

Hereinafter, a system for creating musical content using a client terminal in accordance with one embodiment of the present invention will be described in detail.

FIG. 1 is a diagram of a system for creating musical content using a client terminal in accordance with an embodiment of the present invention.

Referring to FIG. 1, the system generally includes a client terminal, a voice synthesis server, a voice synthesis transmission server, and a network connecting these components to each other.

The client terminal edits lyrics and a sound source, reproduces a sound corresponding to a location of a piano key, edits a vocal effect, and transmits music information obtained by editing a singer sound source and a track corresponding to a vocal part to reproduce music synthesized and processed by the voice synthesis server. The voice synthesis server acquires the music information transmitted from the client terminal to extract, synthesize, and process a sound source. The voice synthesis transmission server transmits the music created by the voice synthesis server to the client terminal.

FIG. 2 is a block diagram of a client terminal of the system for creating musical content using a client terminal in accordance with one embodiment of the present invention. Referring to FIG. 2, the client terminal 200 includes: a lyrics editing unit 210 for editing lyrics; a sound source editing unit 220 for editing a sound source; a vocal effect editing unit 240 for editing a vocal effect; a singer and track editing unit 250 for selecting a singer sound source corresponding to a vocal part and editing various tracks; and a reproduction unit 260 for receiving and reproducing a signal synthesized by the voice synthesis server from the voice synthesis transmission server.

The client server 200 may further include a virtual piano unit 230 for reproducing a sound corresponding to a location of a piano key according to an additional type thereof.

As shown in FIG. 5, in order to perform the editing function, a creation program for utilizing the system according to the present invention is mounted to a client terminal of a user.

When a lyrics editing area 410, on which a user can edit lyrics, a background music editing area 420, on which a user can edit background music, a virtual piano area 430, on which a user can manipulate a piano key, a vocal effect editing area 440, on which a user can edit a vocal effect, a singer setting area 450, on which a user can edit a singer or a track, and a setting area 460, on which a user can select file, editing, audio, view, work, track, lyrics, setting, singing technique and help, are output on a screen, the creation program allows the user to perform desired editing.

A minimum unit (syllable) of a word may be input to the lyrics editing area 410, and the lyrics editing area 410 displays a sound of the syllable and a pronunciation symbol.

The syllable has a pitch and a length.

A conventional sound source such as WAV and MP3 is input to the background music editing area 420 and is edited therein.

The virtual piano area 430 provides a function corresponding to a piano, and reproduces a sound corresponding to a location of the key of the piano.

The singer setting area 450 allows selection of a singer sound source corresponding to a vocal part, and provides a function of editing various tracks to perform a function of singing by various singers.

The setting area 460 may set a singing technique setting by which various singing techniques may be set, editing key, editing screen option, and the like.

These areas are provided through the lyrics editing unit 210 for editing lyrics, the sound source editing unit 220 for editing a sound source, the vocal effect editing unit 240 for editing a vocal effect, and the singer and track editing unit 250 for selecting a singer sound source corresponding to a vocal part and editing various tracks, and the information edited by the editing unit is acquired by a central control unit (not shown) to be transmitted to the voice synthesis transmission server.

The voice synthesis transmission server 300 includes: a client multiple connection management unit 310 for managing music synthesis requests of a plurality of client terminals in sequence or in parallel such that the plurality of client terminals simultaneously connect to the voice synthesis server to issue voice synthesis requests; a music data compression processing unit 320 for compressing music data to efficiently transmit the music data in a restricted network environment; a music data transmission unit 330 for transmitting music information synthesized in response to the music synthesis request of the client terminal to a client; and an additional service interface processing unit 340 for transferring voice synthesis based musical content to provide the musical content to a mobile communication company bell sound service and a ringtone service.

The client multiple connection management unit 310 performs a function of managing music synthesis requests of the plurality of client terminals in sequence or in parallel such that the client terminals can simultaneously connect to a voice synthesis server to issue voice synthesis requests.

That is, the client multiple connection management unit 310 manages a sequence for sequential processing according to a connection time of the client terminal.

The music data compression processing unit 320 compresses music data to efficiently transmit the music data in a restricted network environment, and receives music synthesis request data from the client terminal to compress the music data. It should be understood that the voice synthesis server has a decryption unit for decompression.

Thereafter, the music data transmission unit 330 transmits music information synthesized in response to the music synthesis request of the client terminal to a client.

It should be understood that the music data transmission unit is used even when the music information synthesized by the music synthesis server is transmitted to the client terminal again.

The additional service interface processing unit 340 performs a function of transferring voice synthesis based musical content to an external system to provide the musical content to a mobile communication company bell service and a ringtone service, and is responsible for circulating musical content created by clients through electronic communication.

The external system is a system for receiving the musical content provided by the voice synthesis server of the present invention, and for example, refers to a mobile communication company server that provides a bell sound service, and a mobile communication company server that provides a ringtone service.

FIG. 3 is a block diagram of a voice synthesis server of the system for creating musical content using a client terminal in accordance with one embodiment of the present invention.

Referring to FIG. 3, the voice synthesis server 100 in accordance with the embodiment of the invention includes: a music information acquisition unit 110 for acquiring lyrics, a singer, a track, a musical scale, a sound length, a bit, a tempo, and a musical effect transmitted from a client terminal; a phrase analysis unit 120 for analyzing a sentence of the lyrics acquired by the music information acquisition unit and converting the analyzed sentence into a form defined according to linguistic characteristics; a pronunciation conversion unit 130 for converting the data analyzed by the phrase analysis unit based on a phoneme; an optimum phoneme selection unit 140 for selecting an optimum phoneme corresponding to the lyrics analyzed by the phrase analysis unit and the pronunciation conversion unit according to a predefined rule; a sound source selection unit 150 for acquiring singer information acquired by the music information acquisition unit and selecting a sound source, corresponding to the phoneme selected through the optimum phoneme selection unit from a sound source database, as a sound source of the acquired singer information; a rhythm control unit 160 for acquiring an optimum phoneme selected by the optimum phoneme selection unit according to a sentence characteristic of the lyrics and controlling a length and a pitch when the optimum phonemes are connected to each other for synthesis; a voice conversion unit 170 for acquiring a sentence of the lyrics synthesized by the rhythm control unit and matching the sentence of the acquired lyrics such that the sentence is reproduced according to a musical scale, a sound length, a bit, and a tempo acquired by the music information acquisition unit; a tone conversion unit 180 for acquiring the voice converted by the voice conversion unit and matching a tone with the converted voice such that the tone is reproduced according to a musical effect acquired by the music information acquisition unit; and a song and background music synthesis unit 190 for synthesizing background music information acquired by the music information acquisition unit with the tone finally converted by the tone conversion unit.

The music information acquisition unit 110 acquires information about lyrics, a singer, a track, a musical scale, a sound length, a bit, a tempo, and a musical effect transmitted from a client terminal to reproduce music.

That is, a musical content creating program is mounted to the client terminal of the present invention and is output on a screen such that an operator can perform musical content using a character-sound synthesis as shown in FIG. 5.

Information about the lyrics, singer, track, musical scale, sound length, bit, tempo and musical effect is stored in the music information data base 195 to be managed, and the music information acquisition unit acquires the information stored in the music information database with reference to the information required for reproduction of music selected by a client.

The creating program is output on a screen of a user terminal such that a user can select various operation modes required for creation of musical content, and if the user selects lyrics, a singer, a track, a musical scale, a sound length, a bit, a tempo, a musical effect, and a singing technique that are input to reproduce music, the selected information is transmitted to the voice synthesis server and is acquired by the music information acquisition unit 110.

Then, the sentence of the lyrics acquired by the music information acquisition unit is analyzed by the phrase analysis unit 120 and is converted into a form defined according to linguistic characteristics.

The linguistic characteristics refer to, for example, in the case of Korean, a sequence of a subject, an object, a verb, a postpositional particle, an adverb, and the like, and all languages including English and Japanese have such characteristics.

The defined form refers to classification according to a morpheme of a language, and the morpheme is a minimum unit having a meaning in a language.

For example, a sentence of ‘dong hae mul gwa baek du san i’ is classified into ‘dong hae mul’, ‘gwa’, ‘baek du san’, and ‘i’ according to morphemes thereof.

After the classification according to the morphemes, the components of the sentence are analyzed. For example, the components of the sentence are analyzed into a noun, a postpositional particle, an adverb, an adjective, and a verb. For example, ‘dong hae mul’ is a noun, ‘gwa’ is a postpositional particle, ‘baek du san’ is a noun, and ‘i’ is a postpositional particle.

That is, if the selected lyrics are Korean, they are converted into a form defined according to characteristics of Korean.

The data analyzed by the phrase analysis unit is received from the pronunciation conversion unit 130 and is converted based on a phoneme, and an optimum phoneme corresponding to the lyrics analyzed by the phrase analysis unit and the pronunciation unit through the optimum phoneme selection unit 140 is selected according to a predefined rule.

The pronunciation conversion unit performs conversion based on a phoneme, and converts the sentence that has been classified and analyzed into a pronunciation form according to the Korean language.

For example, ‘dong hae mul gwa baek du san i’ will be expressed by ‘dong hae mul ga baek ddu sa ni’, and ‘dong hae mul gwa’ is converted into ‘do+ong+Ohae+aemu+mul+wulga’ if it is classified based on phonemes.

The optimum phoneme selection unit 140 selects optimum phonemes such as do, ong, Ohae, aemu, mul, and wulga when the analyzed lyrics are dong hae mul.

The sound source selection unit 150 acquires singer information acquired by the music information acquisition unit and selects a sound source corresponding to the phoneme selected through the optimum phoneme selection unit from the sound source database 196 as a sound source of the acquired singer information.

That is, if Girl's Generation is selected as a singer, a sound source corresponding to Girl's Generation is selected from the sound source database.

Track information may be provided in addition to the singer information, and if a user selects a track in addition to a singer, track information may be provided.

The rhythm control unit 160 controls a length and a pitch when the optimum phonemes are connected for synthesis such that a minimum phoneme selected by the optimum phoneme selection unit according to the sentence characteristics of lyrics is acquired for natural vocalization.

The sentence characteristics refer to a rule, such as a prolonged sound rule or palatalization, which is applied when a sentence is converted into pronunciations, that is, a linguistic rule in which expressive symbols expressed by characters become different from pronunciation symbols.

The length refers to a sound length corresponding to lyrics, that is, 1, 2, 3 beats, and the pitch refers to a musical scale of lyrics, that is, a sound height, such as do, re, mi, fa, sol, la, ti, or do, which is defined in music.

That is, the rhythm control unit 160 controls the length and the pitch when the optimum phonemes are connected for synthesis such that natural vocalization can be achieved according to the sentence characteristics of lyrics.

The voice conversion unit 170 functions to acquire a sentence of lyrics synthesized by the rhythm control unit, and matches the acquired sentence of the lyrics such that the sentence can be reproduced according to the musical scale, sound length, bit and tempo acquired by the music information acquisition unit.

That is, the voice conversion unit 170 functions to covert a voice according the musical scale, sound length, bit and tempo and, for example, reproduces a sound source corresponding to ‘dong’ with a musical scale (pitch) of ‘sol’, a sound length of one beat, a beat of four-four time, and a tempo of 120 beats per minute (BMP).

The musical scale (pitch) refers to a frequency of a sound, and the present invention provides a virtual piano function such that a user can easily designate a frequency of a sound.

The sound length refers to a length of a sound, and a note as in a score is provided such that the sound length can be easily edited.

The basically provided note includes a dotted note (1), a half note (1.2), a quarter note (¼), an eighth note (⅛), a sixteenth note ( 1/16), a thirty second note ( 1/32), and a sixty fourth note ( 1/64).

The beat refers to a unit of time in music, and includes half time, quarter time, and eighth time.

The numbers corresponding to a denominator include 1, 2, 4, 8, 16, 32, and 64, and the numbers corresponding to a numerator include 1 to 256.

The tempo refers to a progress speed of a musical piece, and generally includes numbers of 20 to 300. A smaller number indicates a low speed, and a larger number indicates a high speed.

Generally, a speed of one beat is 120.

The tone conversion unit 180 functions to acquire a voice converted by the voice conversion unit and match a tone with the converted voice such that the acquired voice can be reproduced according to a vocal effect or a singing technique acquired by the music information acquisition unit.

For example, a musical effect such as a vibration or an attack is applied to a sound source of ‘dong’ to change a tone.

The musical effect and the singing technique provide a function of maximizing a musical effect, and the musical effect converts a tone as a function of supporting a natural vocalization method of a person.

As shown in FIG. 5, the creating program provides VEL (Velocity), DYN (Dynamics), BRE (Breathiness), BRI (Brightness), CLE (Clearness), OPE (Opening), GEN (Gender Factor), POR (Portamento Timing), PIT (Pitch Bend), PBS (Pitch Bend Sensitivity), VIB (Vibration), and the like to a client terminal.

VEL (Velocity) is an attack, and as a VEL value becomes higher, a consonant becomes shorter such that attack feeling increases. DYN (Dynamics) is strength to control dynamics (intensity and softness of a sound) of a singer.

If a BRE (Breathiness) value becomes higher, a breath is added. BRI (Brightness) increases or decreases a frequency component having a high sound, and if a BRI value is high, a bright sound is provided, whereas if a BRI value is low, a gloomy and warm sound is provided.

CLE (Clearness) is similar to BRI but has a different principle. That is, if a CLE value is high, a sharp and clear sound is provided, whereas if a CLE value is low, a low and heavy sound is provided.

OPE (Opening) corresponds to simulated variation of a tone by an open state of a mouth, and if an OPE value is high, a clear sound is provided, whereas if an OPE value is low, an unclear sound is provided.

GEN (Gender Factor) allows wide modification of characteristics of a singer, and if a GEN value is high, a masculine sound is provided, whereas a GEN value is low, a feminine sound is provided.

POR (Portamento Timing) adjusts a point where a pitch is changed. PIT (Pitch Bend) corresponds to adjusting an EQ bend for a pitch. PBS (Pitch Bend Sensitivity) corresponds to adjusting sensitivity or emotion for adjustment of a pitch. VIB (Vibration) performs a function of adjusting quivering of a sound.

The singing technique refers to a singing method, and various singing techniques can be realized by processing a technique such as a vocal music effect.

For example, singing techniques such as a feminine voice, masculine voice, child voice, robot voice, pop song voice, classic music voice, and bending are provided.

The voice synthesis server 100 further includes a singing and background music synthesis unit 190 for synthesizing background music information acquired by the music information acquisition unit and a tone finally converted by the tone conversion unit.

For example, when a sound source such as “dong hae mul gwa baek du san i” is reproduced, background music (usually, music played by an instrument) of the song is synthesized.

That is, a finished form of music is output by synthesizing the finally converted tone with background music.

The music information acquisition unit 110 for acquiring the music information may include: a lyrics information acquisition unit (not shown) for acquiring lyrics information; a background music information acquisition unit (not shown) for acquiring background music sound source information selected from background music sound sources stored in the sound source database; a vocal effect acquisition unit (not shown) for acquiring vocal effect information adjusted by a user; and a singer information acquisition unit (not shown) for acquiring singer information.

The system may further include a piano key location acquisition unit (not shown) for acquiring piano key location information selected by a user from a virtual piano output on a screen according to an additional aspect.

The piano key location information defines a frequency corresponding to a musical scale (pitch) of a piano key.

With the configuration and operation of the musical content creation system according to the present invention, when musical content is easily edited by anyone in a mobile environment, a musical voice corresponding to the edited musical content may be provided to a user through synthesis of the musical voice. Accordingly, the musical content creation system may allow individually created content to be circulated through electronic or off-line systems, may be used for an additional service for application of musical content, such as a bell sound and ringtone (ring back tone: RBT) in a mobile phone, may be used for reproduction of music and voice guide in various types of portable devices, may provide a voice guide services with an accent similar to a human voice in an automatic response system (ARS) or a navigation system (map guide device), and may allow an artificial intelligent robot to speak with an accent similar to a human voice and to sing.

It will be understood by those skilled in the art that the present invention can be carried out in various forms without changing the technical spirit and essential features of the present invention. Therefore, it should be understood that the aforementioned embodiments are provided for illustration only in all aspects and should not be construed as limiting the present invention.

It should be understood that various modifications, variations, and alterations can be made without departing from the spirit and scope of the present invention, as defined by the appended claims and equivalents thereof.

### INDUSTRIAL APPLICABILITY

According to the present invention, when musical content is easily edited by anyone in a mobile environment, a musical voice corresponding to the edited musical content may be provided to a user through synthesis of the musical voice. Thus, individually created content may be circulated through electronic or off-line systems, and may be used to provide a bell sound or ringtone (ring back tone: RBT) in a mobile phone. Therefore, the present invention may be widely utilized in a musical content creation field.

1. A system for creating musical content using a client terminal, comprising:
a client terminal for editing lyrics and a sound source, reproducing a sound corresponding to a location of a piano key, and editing a vocal effect or transmitting music information to the voice synthesis server to reproduce music synthesized and processed by the voice synthesis server, the music information being obtained by editing a singer sound source and a track corresponding to a vocal part;
a voice synthesis server for obtaining the music information transmitted from the client terminal to extract, synthesize, and process a sound source corresponding to the lyrics; and
a voice synthesis transmission server for transmitting the music created by the voice synthesis server to the client terminal.

2. The system according to claim 1, wherein the client terminal comprises:
a lyrics editing unit for editing lyrics;
a sound source editing unit for editing a sound source;
a vocal effect editing unit for editing a vocal effect;
a singer and track editing unit for selecting a singer sound source corresponding to a vocal part and editing a plurality of tracks; and
a reproduction unit for receiving and reproducing a signal synthesized by the voice synthesis server from the voice synthesis transmission server.

3. The system according to claim 1, wherein the client terminal comprises:
a lyrics editing unit for editing lyrics;
a sound source editing unit for editing a sound source;
a virtual piano unit for reproducing a sound corresponding to a location of a piano key;
a vocal effect editing unit for editing a vocal effect;
a singer and track editing unit for selecting a singer sound source corresponding to a vocal part and editing a plurality of tracks; and
a reproduction unit for receiving and reproducing a signal synthesized by the voice synthesis server from the voice synthesis transmission server.

4. The system according to claim 1, wherein the voice synthesis server comprises:
a music information acquisition unit for acquiring lyrics, a singer, a track, a musical scale, a sound length, a bit, a tempo, and a musical effect transmitted from the client terminal;
a phrase analysis unit for analyzing a sentence of the lyrics acquired by the music information acquisition unit and converting the analyzed sentence into a form defined according to linguistic characteristics;
a pronunciation conversion unit for converting data analyzed by the phrase analysis unit based on a phoneme;
an optimum phoneme selection unit for selecting an optimum phoneme corresponding to the lyrics analyzed by the phrase analysis unit and the pronunciation conversion unit according to a predefined rule;
a sound source selection unit for acquiring singer information acquired by the music information acquisition unit and selecting a sound source, corresponding to the phoneme selected through the optimum phoneme selection unit from a sound source database, as a sound source of the acquired singer information;
a rhythm control unit for acquiring an optimum phoneme selected by the optimum phoneme selection unit according to a sentence characteristic of the lyrics and controlling a length and a pitch when the optimum phonemes are connected to each other for synthesis;
a voice conversion unit for acquiring a sentence of the lyrics synthesized by the rhythm control unit and matching the sentence of the acquired lyrics such that the sentence is reproduced according to a musical scale, a sound length, a bit, and a tempo acquired by the music information acquisition unit;
a tone conversion unit for acquiring the voice converted by the voice conversion unit and matching a tone with the converted voice such that the tone is reproduced according to a musical effect acquired by the music information acquisition unit; and
a song and background music synthesis unit for synthesizing background music information acquired by the music information acquisition unit with the tone finally converted by the tone conversion unit.

5. The system according to claim 4, wherein the music information acquisition unit comprises:
a lyrics information acquisition unit for acquiring lyrics information;
a background music information acquisition unit for acquiring background music sound source information selected from background music sound sources stored in the sound source database;
a vocal effect acquisition unit for acquiring vocal effect information adjusted by a user; and
a singer information acquisition unit for acquiring singer information.

6. The system according to claim 4, further comprising: a piano key location acquisition unit for acquiring piano key location information selected by a user from a virtual piano.

7. The system according to claim 1, wherein the voice synthesis transmission server includes:
a client multiple connection management unit for managing music synthesis requests of a plurality of client terminals in sequence or in parallel such that the plurality of client terminals simultaneously connect to the voice synthesis server to issue voice synthesis requests;
a music data compression processing unit for compressing music data to efficiently transmit the music data in a restricted network environment;
a music data transmission unit for transmitting music information synthesized in response to the music synthesis request of the client terminal to a client; and
an additional service interface processing unit for transferring voice synthesis based musical content to an external system to provide the musical content to a mobile communication company bell sound service and a ringtone service.
